(19) United States
(12) Patent Application Publication
(10) Pub. No.: US 2026/0113579 A1
(43) Pub. Date: Apr. 23, 2026

(54) HEARING DEVICE WITH MACHINE LEARNING MODEL THAT COMPENSATES FOR HEARING PATHOLOGY IN LATENT REPRESENTATION

(71) Applicant: Starkey Laboratories, Inc., Eden Prairie, MN (US)

(72) Inventors: Deepak Kadetotad, Tempe, AZ (US); Martin McKinney, Minneapolis, MN (US); Kenneth Kragh Jensen, Shakopee, MN (US); Alaganandan Ganeshkumar, North Attleboro, MA (US); Amit Shahar, Hod Hasharon (IL)

(21) Appl. No.: 19/361,659

(22) Filed: Oct. 17, 2025

Related U.S. Application Data
(60) Provisional application No. 63/710,260, filed on Oct. 22, 2024.

(51) Int. Cl. H04R 25/00; G10L 21/0224; G10L 21/0272; G10L 25/30

(52) U.S. Cl. CPC H04R 25/507; G10L 21/0224; G10L 21/0272; G10L 25/30; H04R 2225/43

(57) ABSTRACT

An ear-wearable device includes an acoustic sensor that receives ambient sound and produces an input signal. The device includes an acoustic transducer that reproduces sound in an ear of a user based on an output signal. A machine learning processing path includes: an encoder layer that encodes the input signal into a latent representation; a sound enhancement layer that produces an enhanced latent representation that provides an audio enhancement independent of an individual hearing pathology; a tuning layer that is configured to represent a user-specific hearing pathology and that modifies the enhanced latent representation to provide a tuned and enhanced latent representation that tailors the audio enhancement to compensate for the user-specific hearing pathology; and a decoder layer that decodes the tuned and enhanced latent representation to produce the output signal.

This application claims the benefit of U.S. Provisional Application No. 63/710,260, filed Oct. 22, 2024, the disclosure of which is incorporated by reference herein in its entirety.

### SUMMARY

This application relates generally to ear-level electronic systems and devices, including hearing aids, personal amplification devices, and hearables. In one embodiment, an ear-wearable device includes an acoustic sensor that receives ambient sound and produces an input signal. The device includes an acoustic transducer that reproduces sound in an ear of a user based on an output signal. A machine learning processing path is coupled to the acoustic sensor and the acoustic transducer. The machine learning processing path includes: an encoder layer that encodes the input signal into a latent representation; a sound enhancement layer that produces an enhanced latent representation that provides an audio enhancement independent of an individual hearing pathology; a tuning layer that is configured to represent a user-specific hearing pathology and that modifies the enhanced latent representation to provide a tuned and enhanced latent representation that tailors the audio enhancement to compensate for the user-specific hearing pathology; and a decoder layer that decodes the tuned and enhanced latent representation to produce the output signal.

In another embodiment, a method of processing sound in an ear-wearable device involves producing an input signal from one or more acoustic sensors of the ear-wearable device. The input signal is input to a machine learning processing path. The machine learning processing path trained to perform: encoding the input signal into a latent representation; producing an enhanced latent representation that provides an audio enhancement independent of an individual hearing pathology; modifying the enhanced latent representation to provide a tuned and enhanced latent representation that tailors the audio enhancement to compensate for a user-specific hearing pathology; decoding the tuned and enhanced latent representation to produce an output signal; and reproducing the output signal in an ear of a user based via one or more acoustic transducers of the hearing device.

The figures and the detailed description below more particularly exemplify illustrative embodiments.

### BRIEF DESCRIPTION OF THE DRAWINGS

The discussion below makes reference to the following figures.

FIG. 1 is an illustration of a processing path of an ear-wearable device;

FIG. 2 is a block diagram showing a machine-learning-based sound processor according to an example embodiment;

FIGS. 3 and 4 are a block diagrams showing preparation and use of machine learning training data according to example embodiments;

FIG. 5 is a block diagram a neural network according to an example embodiment;

FIGS. 6 and 7 are flowcharts a methods according to an example embodiments; and

FIG. 8 is a block diagram of a hearing device and system according to an example embodiment.

The figures are not necessarily to scale. Like numbers used in the figures refer to like components. However, it will be understood that the use of a number to refer to a component in a given figure is not intended to limit the component in another figure labeled with the same number.

### DETAILED DESCRIPTION

Embodiments disclosed herein are directed to an ear-worn or ear-level electronic hearing device. Such a device may include cochlear implants and bone conduction devices, without departing from the scope of this disclosure. The devices depicted in the figures are intended to demonstrate the subject matter, but not in a limited, exhaustive, or exclusive sense. Ear-worn electronic devices (also referred to herein as “hearing aids (HA),” “hearing devices,” “ear-wearable devices,” and “audio wearables (AW)”), such as hearables (e.g., wearable earphones, ear monitors, and earbuds), hearing aids, hearing instruments, and hearing assistance devices, typically include an enclosure, such as a housing or shell, within which internal components are mounted or disposed.

Embodiments described herein further relate to audio enhancement features in an ear-wearable device, such as noise reduction and speech enhancement. The current situation in which these embodiments are intended for use involves the widespread use of AW devices, such as earbuds, hearing aids, and other wearable audio devices, in various environments. These devices are commonly used by individuals seeking to listen to music, communicate, or enhance their hearing abilities.

Audio wearable devices often use sophisticated algorithms to process sound. These algorithms may be similar to those used in devices for non-hearing impaired users, such as active noise reduction algorithms. Other sound processing algorithms may target specific hearing pathologies, such as decreased sensitivity to higher frequencies and difficulty in understanding speech in noisy environments. Digital signal processing (DSP) circuits and software have been developed to provide these and other sound processing functions. These DSP implementations can be implemented on relatively inexpensive and power-efficient hardware.

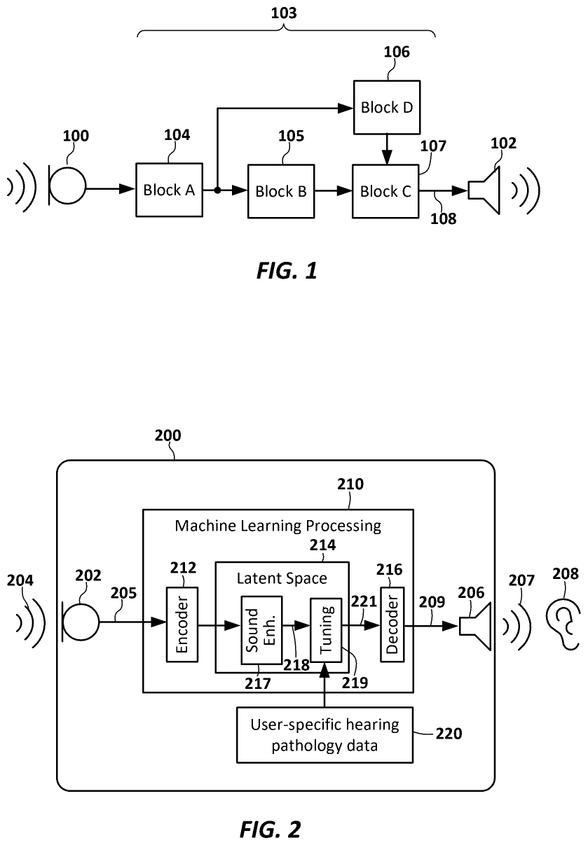

In FIG. 1, a diagram illustrates a sound processing path that illustrates some aspects of existing DSP implementations in a hearing device. Generally, a hearing device includes a microphone 100 that receives ambient sounds and a receiver 102 that reproduces processed sound in the user's ear. Other sources of sound (e.g., recorded sound) could be used instead of the microphone 100, but for devices such as hearing aids, at least one microphone will be included. A processing path 103 includes processing blocks 104-107 that perform individual functions, e.g., filtering, summation, subtraction, compression, time-frequency gain modulation, etc.

Generally, the blocks 104-107 interact along the processing path 103 to provide a number of different enhancements that are reflected in a final output signal 108 sent to the receiver 102. For example, sound processing algorithms for feedback suppression, compression/expansion, equalization, speech enhancement, and the like may simultaneously process the output signal 108 and be independently adaptable, e.g., to adjust to current operating conditions.

One issue with a processing path as shown in FIG. 1 is unanticipated interactions between different processing modules. For example, some processing such as feedback cancellation can exhibit unwanted behavior if there are sudden changes in characteristics of the audio stream. Other modules, such as dynamic range expansion/compression may operate best if they can react quickly to adapt the audio stream, e.g., to prevent unwanted artifacts from being perceived by the user. Given the potential for interaction between multiple such modules, tuning the parameters of the different modules to prevent interference with one another can be challenging.

Machine learning algorithms have been employed to provide sound processing functions in a hearing device. Generally, machine learning uses a data structure such as a neural network that is trained on a set of data and adapts its internal state based on the training to provide a specific output, e.g., a classification of a sound or other sensed event, a modified data stream that is altered in some specific way, etc. Some machine learning models can be resource-intensive to train, but after training, can be operated on resource-limited devices such as AW devices. Even so, compared to other portable electronics (e.g., mobile phones), AW devices are constrained by limited resources such as power and processing capabilities. These constraints can complicate the task of integrating machine learning with existing DSP algorithms, e.g., they compete for limited computing resources.

Overall, the current situation suggests the need for more refined machine learning solutions in AW devices. The methods and apparatuses described herein aim to address these challenges by integrating machine learning models such as deep neural networks (DNN) into in-ear device's hardware, offering continuous and real-time enhancement without compromising performance. Generally, the device uses a machine learning model to provide a combination of processing operations such that a single machine learning model can replace a number of DSP-type processing modules.

In FIG. 2, a diagram illustrates an example of an ear-wearable device 200 utilizing machine learning according to an example embodiment. The ear-wearable device includes an acoustic sensor 202 (e.g., one or more microphones) that receives ambient sound 204 and produces an input signal 205. An acoustic transducer 206 (e.g., one or more loudspeakers) reproduces sound 207 in an ear 208 of a user based on an output signal 209.

A machine learning processing path 210 is coupled to the acoustic sensor 202 and the acoustic transducer 206. The machine learning processing path 210 includes any combination of hardware (e.g., processors, co-processors, application-specific integrated circuits), software and firmware. Software refers to at least instructions temporarily stored in a volatile memory and/or changeably stored in a non-volatile memory, e.g., randomly rewritable. Firmware refers to instructions stored in a non-volatile memory that is not actively changeable, e.g., unchangeably coded in hardware, changed by re-flashing a firmware image.

The machine learning processing path 210 includes an encoder layer 212 that encodes the input signal 205 into a latent representation, as indicated by latent space 214. Generally, the latent space 214 is a reduced-size characterization of the input space that captures the most relevant characteristics of the input. The latent space 214 is sometimes referred to as a bottleneck, as it has smaller dimensionality than the input and output space. Latent representations can be converted back to output space (e.g., a time-domain audio output signal 209) via a decoder layer 216 that is derived from the encoder layer 212.

In some simple applications, a predefined mapping from an input to latent space can be devised, e.g., for binary data compression. For machine learning models, the latent space is often learned using an autoencoder algorithm. For example, a neural network can be structured in such a way that it can learn and describe latent attributes of input data. Once trained, this latent space neural network can be used as an encoder section of a neural network, with its inverse being used as a decoder.

The latent space 214 is shown with a sound enhancement layer 217 that produces an enhanced latent representation 218. The enhanced latent representation 218 provides an audio enhancement independent of an individual hearing pathology. For example, the sound enhancement layer 217 could be trained to enhance speech according to some predefined “normal” hearing profile. The sound enhancement layer 217 could be trained for a number of such enhancement options, e.g., de-noising, active noise cancellation, reverberation mitigation, source separation, environmental scene understanding, etc. These enhancements can be beneficial for users regardless of impairment or lack thereof.

In order to improve hearing for device users, changes are made to the output 209 to compensate for an individual hearing pathology. This often involves changing gain at specific frequency bands and applying wideband compression/expansion. While a different machine learning model could be trained for each user's individual hearing pathologies, it may not be practical to do so. Instead, a collection of data that characterizes individual hearing pathologies, referred to herein generally as “audiograms,” can be collected and incorporated into the training of the machine learning processing path 210. The machine learning processing path 210 will therefore have additional “knobs” that allow changing the output to suit individual needs. A user-specific device will have, for example, data 220 describing an individual pathology that is diagnosed and measured by a practitioner. This user-specific pathology data 220 is fed into or is part of a tuning layer 219.

The tuning layer 219 is configured to receive data 220 describing the user-specific hearing pathology and modifies the enhanced latent representation 218 to provide a tuned and enhanced latent representation 221 that tailors the audio enhancement to compensate for the user-specific hearing pathology. Note that while the sound enhancement layer 217 and the tuning layer 219 are shown as separate elements for purposes of illustration, they may be combined into a single machine learning structure. Or if separate, the sound enhancement layer 217 and the tuning layer 219 may use separate types of models, e.g., any combination selected from: a fully-convolutional time-domain audio separation network, a recurrent neural network, a structured state space model, and a transformer neural network. The decoder layer 216 decodes the tuned and enhanced latent representation to produce the output signal. The decoder layer 216 is generally an inverse function of the encoder layer 212.

The ear-wearable device 200 may be part of a system of devices, e.g., second ear-wearable device, mobile device, wearable device, etc. A second ear-wearable device may be similarly configured as the illustrated device 200, except the second device may store different user-specific pathology data 220 tailored to a different ear. Generally, such devices can be configured with a trained machine learning model and be adapted for particular users by uploading an audiogram prepared in response to a hearing diagnostic.

The embodiment described above can use any suitable data or characteristics of patients to create gains or any other suitable processing settings, e.g., measured audiograms, gender, age, speech-in-noise scores, etc. For example, the embodiment can use measured audiograms of patients to create the gains (and other processing settings) for the hearing aid, e.g., based on a common standard or guideline. Existing code modules can be used in training of the tuning layer 219 described above. For example, an existing HA simulator can operate offline (e.g., on a development computer) to mimic the audio processing of a configured HA. The HA simulator can create audio that has been ‘treated’ based on a specific audiogram-based gain. A large database of these audiograms can be leveraged to train the machine learning model to account for different remedial measures in the database, and the trained tuning layer will be able to abstract this knowledge to adapt processing (e.g., interpolate) for an audiogram not in the database. Thus, once the machine learning model is fully trained on both sound inputs 205 and the database, it can adapt to an arbitrary audiogram provided as data 220.

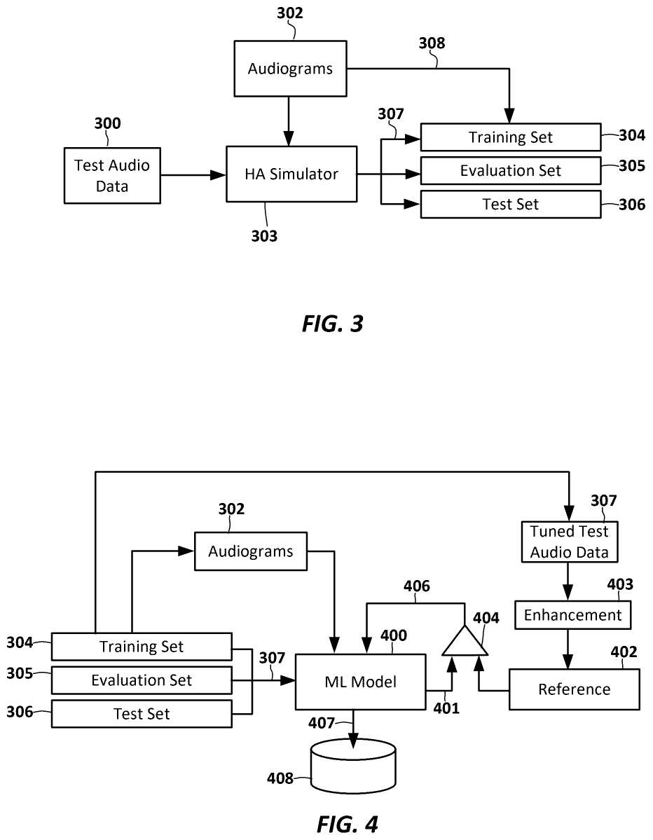

In FIG. 3, a block diagram illustrates an example of preparing training data for training a machine learning model according to an example embodiment. Test audio data 300 and audiograms 302 are randomly selected and fed through an HA simulator 303 to create tuned audio representations 307. In one or more embodiments, auditory models of, e.g., loudness, masking, etc., can also be utilized to generate the tuned test audio representations 307 or as a part of a training cost function. The tuned audio representations are compiled into training, evaluation, and test sets 304-306 for a machine learning model. For example, one sample of the test audio data (e.g., a sound clip) will be associated with one of the audiograms used to produce one of the tuned audio representations 307. The audiograms 302 (or a reference thereto) are added to the data sets 304-306 as indicated by line 308, where they are associated with tuned audio representations 307 that they were used to create. Generally, the training set 304 is used to train the model, and the evaluation and test sets 305, 306 are used to validate versions of the trained model. The evaluation and test sets 305, 306 can be used to refine the model if issues are seen with the initial training.

In FIG. 4, a diagram shows details of training a machine learning (ML) model according to an example embodiment. As seen in FIG. 4, the data sets 304-306 are fed into the ML model 400 that compares its output 401 to reference data 402. The reference data 402 includes the tuned test audio data 307 that has been subjected to the desired audio enhancements 403 (e.g., de-noising, source separation) independently of a specific pathology. Note that the reference data 402 (or a reference thereto) for each sample of test audio data 300 could be added to the training data sets 304-306 in addition to tuned test audio data 307. In other words, the training does not require on the fly enhancement 403 of the audio. The audiograms 302 associated with the tuned test audio data 307 are also fed into the tuning layer of the model 400 during training, such that the model 400 will be additionally trained to change its state based the audiograms 302 as well as the reference data 402.

As indicated by comparator block 404, differences between the ML model's output 401 and the reference data 402 form error/loss data 406 which is fed back into the model 400 and used to adjust the model's state data, e.g., change values of weights and biases of neural network nodes. This aspect of the neural network training may be implemented using standard gradient descent and back propagation. The comparator block 404 may also include perception-based metrics to improve the quality of audio over baseline, the quality metric being included in the loss/error calculations. For example, the enhancement metric may include a scale-invariant source-to-noise ratio.

The adjustment of the ML model 400 based on training data continues iteratively until the model 400 converges onto a desired behavior, e.g., error/loss 406 is below a threshold, quality metric meets a threshold. As noted above, additional validation tests can be run to ensure the trained model 400 performs as desired, e.g., did not over-fit the training data set 304. After training/validation of the model, the data 407 (e.g., neural network weights) that describes the model 400 is stored in a data storage medium 408 where it can be deployed to operational ear-wearable devices.

By incorporating a reasonably large and varied set of audiograms 302 into the training, the hearing device in which the trained model data 407 is deployed can be personalized to a particular user hearing pathology, e.g., inputting data to the operational model that describes the gain and/or compression targets for specific frequency bins. Note that the latent space of the ML model 400 is learned during training rather than the being represented in some well-defined time-frequency space. Thus, the adjustments to account for hearing pathology are incorporated into training rather than made after training. With a sufficiently large set of audiograms and processed data, the ML model 400 can learn to apply an arbitrary gain and/or compression of a particular user based on inputting audiogram data in a predefined format.

In FIG. 5, a diagram illustrates aspects of a machine learning model 500 according to an example embodiment. The machine learning model 500 in this example is configured as a convolutional recurrent neural network with an auto-encoder architecture. An encoder 502 contains a series of one-dimensional (1-D) convolutional layers (Conv1D) to extract latent features from audio inputs from one or more microphones 504. The encoder 502 can utilize any suitable convolutional layers, e.g., one-dimensional convolutional layers, two-dimensional convolutional layers, transpose convolutional layers, etc. The encoder 502 may be trained to accept other sensor inputs 506, e.g., accelerometer data, which is combined with the microphone data in the encoding. The input data may be any combination of time-domain and frequency-domain representations.

The latent features are processed in a latent space 508, which includes an enhancement layer 510. The enhancement layer 510 is trained to apply non-pathology-specific sound enhancements. In other words, the enhancements are independent of an individual hearing pathology. The enhancement layer 510 can use a convolutional neural network (CNN) such as fully-convolutional time-domain audio separation network as described, for example, in Conv-TasNet: Surpassing Ideal Time-Frequency Magnitude Masking for Speech Separation, by Yi eta al. (arXiv: 1809.07454v3, 15 May 2019). In other embodiments, the recurrent layer can be a recurrent neural network, such as a gated recurrent unit (GRU), long short-term memory (LSTM), etc. The enhancement layer 510 could use a structured state space model (SSM, S4, S5, Mamba, etc.) and/or transformer.

The latent space 508 is also shown with a mask generator 514 (also referred to herein as a tuning layer) that modifies the latent space based on an audiogram 512. The mask generator 514 can use a similar or different structure than the enhancement layer 510, e.g., CNN, GRU, LSTM, SSM, etc. While the enhancement layer 510 and mask generator 514 are shown as discrete components, they could be integrated into a single structure, e.g., a deep neural network (DNN) with recurrent capabilities that is trained to jointly maximize enhancement and adjust output to conform to the audiograms. The decoder 516 is a mirrored structure to the encoder 502 (TransposeConv1D) to synthesize ‘treated’ audio 518.

In one embodiment, a hearing device includes an end-to-end machine learning model which will perform, for example, denoising, source separation, etc., and further apply transformation to the enhanced audio to accommodate a hearing aid users specific audiogram. When implemented using a machine learning accelerator, the model will be able to circumvent frequency resolution limitation brought on by latency and computation constraints in current hearing devices, e.g., DSP implementations.

In Table 1 below, additional details are provided regarding configuration of a machine learning model as described herein according to one example embodiment. A model with similar characteristics can be implemented in other ways as described elsewhere herein and the illustrated example is not meant to be limiting.

TABLE 1

| Deep Neural Network | |
|---|---|
| Parameter | Value |
| Network Topology and use | Input −> 1-D Conv Encoder−> Latent |
| of recurrent units | Space/Bottleneck > 1-D Conv Decoder > |
| | Output (Latent Space/Bottleneck can be |
| | Conv-TasNet, GRU, LSTM, SSM, |
| | transformer) |
| Data format for inputs | Inputs are extracted from the digitized |
| | microphone signal. These inputs may be |
| | extracted directly from the time-domain data |
| | or the microphone signal can be converted to |
| | the frequency domain using techniques such |
| | as the Fast Fourier Transform (FFT). |
| Activation Function | Sigmoid or ReLu activation functions |
| Learning Paradigm | Supervised Learning or Generative |
| | Adversarial Networks (GANs) to minimize |
| | error between ML output and enhanced |
| | speech |
| Training Dataset | Multiple hours of clean speech signals with |
| | audiograms applied in a hearing device |
| | simulator and enhancements applied to |
| | obtain a reference |
| Cost Function | Mean squared error loss |
| Starting Values | Random values |

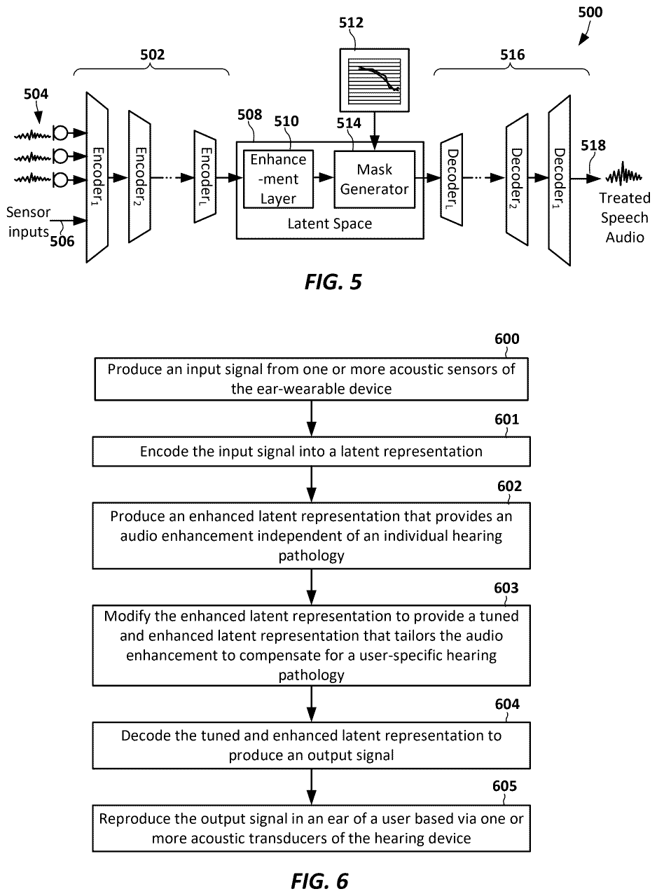

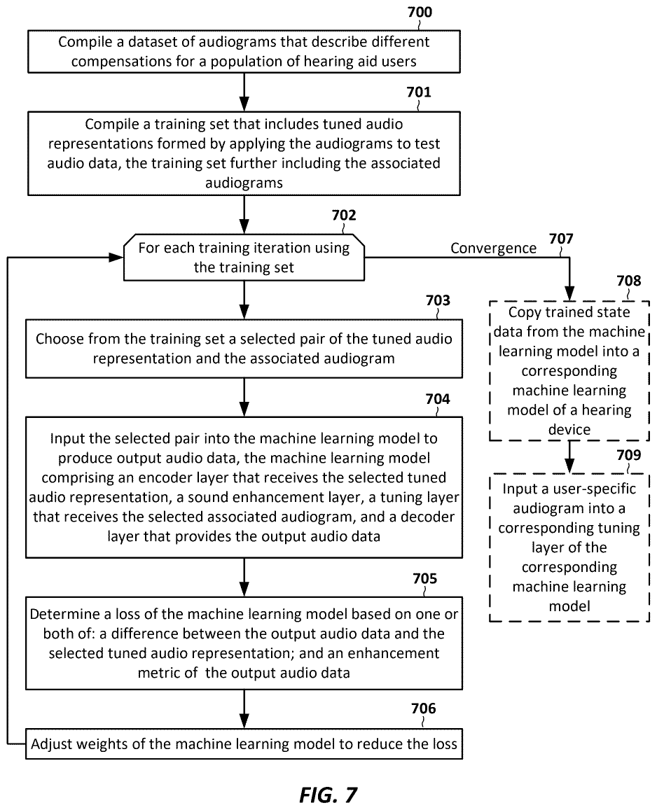

In FIG. 6, a flowchart illustrates a method of processing sound in an ear-wearable device according to an example embodiment. The method may be processor-implemented in an ear-wearable device. The method involves producing 600 an input signal from one or more acoustic sensors of the ear-wearable device. In one or more embodiments, the method can include one or more input signals can also be produced by one or more acoustic sensors that are external to the ear-wearable device. The one or more external acoustic sensors can include any suitable sensor, e.g., a remote microphone or array of microphones. The input signal from the acoustic sensors of the ear-wearable device and/or external acoustic sensors can be input to a machine learning processing path. The machine learning processing path is trained to: encode 601 the input signal into a latent representation; produce 602 an enhanced latent representation that provides an audio enhancement independent of an individual hearing pathology; modify 603 the enhanced latent representation to provide a tuned and enhanced latent representation that tailors the audio enhancement to compensate for a user-specific hearing pathology. The tuned and enhanced latent representation is decoded 604 to produce an output signal. The output signal is reproduced 605 in an ear of a user based via one or more acoustic transducers of the hearing device.

In FIG. 7, a flowchart illustrates a method of training a machine learning model for an ear-wearable device. The model can be trained using any suitable technique, e.g., supervised learning, unsupervised learning, reinforcement learning, a general adversarial network (GAN), etc. For example, a GAN can be utilized to train and/or fine tune a DNN based on hearing impaired perceptual models. The method involves compiling 700 a dataset of audiograms that describe different compensations for a population of hearing aid users. A training set is compiled 701 that includes tuned audio representations formed by applying the audiograms to test audio data. The training set further includes the associated audiograms. Block 702 indicates a loop limit for each training iteration over the training set. Each iteration involves choosing 703 from the training set a selected pair of the tuned audio representation and the associated audiogram.

The selected pair is input 704 into the machine learning model to produce output audio data for the iteration. The machine learning model includes an encoder layer that receives the selected tuned audio representation, a sound enhancement layer, a tuning layer that receives the selected associated audiogram, and a decoder layer that provides the output audio data. Each iteration further involves determining 705 a loss of the machine learning model based on one or both of: a difference between the output audio data and the tuned audio representation; and an enhancement metric of the output audio data. The iteration also involves adjusting 706 weights of the machine learning model to reduce the loss.

Once training is completed, as indicated by convergence line 707, the trained state data is optionally copied 708 from the machine learning model into a corresponding machine learning model of a hearing device. In such a case, a user-specific audiogram is input 709 into a corresponding tuning layer of the corresponding machine learning model. The corresponding machine learning model functions as described, for example, in the flowchart of FIG. 6.

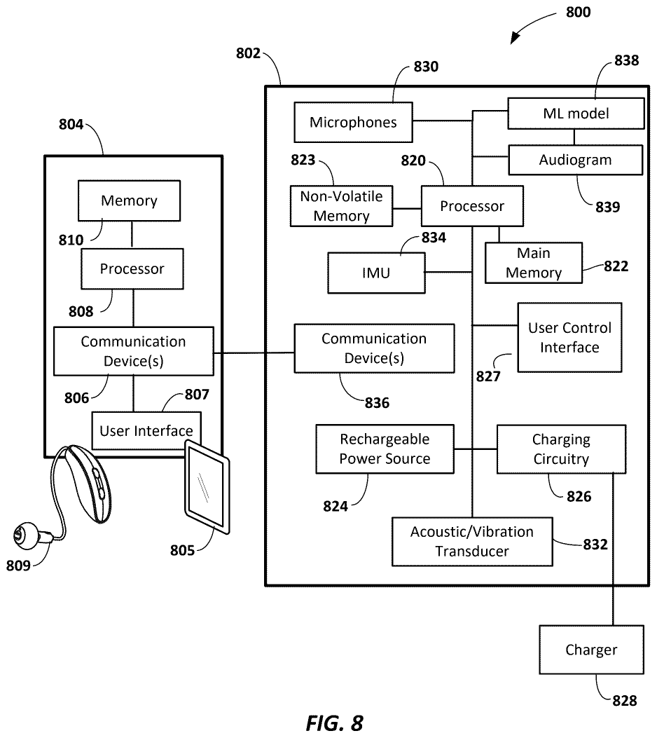

In FIG. 8, a block diagram illustrates a system and ear-wearable/hearing device 800 in accordance with any of the embodiments disclosed herein. The hearing device 800 includes a housing 802 configured to be worn in, on, or about an ear of a wearer. The hearing device 800 shown in FIG. 8 can represent a single hearing device configured for monaural or single-ear operation or one of a pair of hearing devices configured for binaural or dual-ear operation. Where two devices are used, they may be functionally equivalent, e.g., perform the same operations as least as it relates to sound processing. Functionally equivalent devices may still operate differently, e.g., having different physical form for left/right sides, having different ear canal fittings, having different sound processing settings to deal with ear-specific (left or right) pathologies, etc.

The hearing device 800 shown in FIG. 8 includes a housing 802 within or on which various components are situated or supported. The housing 802 can be configured for deployment on a wearer's ear (e.g., a behind-the-ear device housing), within an ear canal of the wearer's ear (e.g., an in-the-ear, in-the-canal, invisible-in-canal, or completely-in-the-canal device housing) or both on and in a wearer's ear (e.g., a receiver-in-canal or receiver-in-the-ear device housing).

The hearing device 800 includes a processor 820 operatively coupled to a main memory 822 and a non-volatile memory 823. The processor 820 can be implemented as one or more of a multi-core processor, a digital signal processor (DSP), a microprocessor, a programmable controller, a general-purpose computer, a special-purpose computer, a hardware controller, a software controller, a combined hardware and software device, such as a programmable logic controller, and a programmable logic device (e.g., FPGA, ASIC). The processor 820 can include or be operatively coupled to main memory 822, such as RAM (e.g., DRAM, SRAM). The processor 820 can include or be operatively coupled to non-volatile (persistent) memory 823, such as ROM, EPROM, EEPROM or flash memory. As will be described in detail hereinbelow, the non-volatile memory 823 is configured to store instructions (e.g., in module 838) that provide functionality described elsewhere herein.

The hearing device 800 includes an audio processing facility (also referred to as an audio processor circuit) operably coupled to, or incorporating, the processor 820. The audio processing facility includes audio signal processing circuitry (e.g., analog front-end, analog-to-digital converter, digital-to-analog converter, DSP, and various analog and digital filters), a microphone arrangement 830, and an acoustic/vibration transducer 832 (e.g., loudspeaker, receiver, bone conduction transducer, motor actuator). The microphone arrangement 830 can include two or more discrete microphones or a microphone array(s) (e.g., configured for microphone array beamforming). Each of the microphones of the microphone arrangement 830 can be situated at different locations of the housing 802. It is understood that the term microphone used herein can refer to a single microphone or multiple microphones unless specified otherwise.

The acoustic transducer 832 produces amplified sound inside of the ear canal. For purposes of this disclosure, “amplified” sound refers to electronically reproduced sound, which typically involves the use of an amplifier to drive the acoustic transducer 832. Amplified sound does not necessarily imply an increase in sound pressure level of ambient sounds relative to what would be experienced with the device removed. In some cases, the amplified sound may result in an overall sound pressure level similar to ambient, e.g., where an equalization curve is applied to affect a small frequency range. In other cases, amplified sound can reduce the sound pressure level in the ear, e.g., via active noise cancellation.

The hearing device 800 may also include a user control interface 827 operatively coupled to the processor 820. The user control interface 827 is configured to receive an input from the wearer of the hearing device 800. The input from the wearer can be any type of user input, such as a touch input, a gesture input, and/or a voice input. The user control interface 827 may be configured to receive an input from the wearer of the hearing device 800.

The hearing device 800 also includes an ML model 838 operable via the processor 820. The module 838 can be implemented in software, hardware (e.g., specialized neural network logic circuitry, general purpose processor), or a combination of hardware and software. During operation of the hearing device 800, the ML module 838 can be used to provide end-to-end digital enhancement to time-domain and/or frequency-domain audio. The enhancement further include modifying the output sound to compensate for a user-specific hearing pathology based on data contained in an audiogram 839 which is stored in memory 822, 823.

The hearing device may include other sensors, such as an IMU 834 to determine an operating context of the hearing device 800, e.g., in-ear, out-of-ear, etc., which can affect how the sound is analyzed and processed. The IMU 834 can also be used to provide inputs to the ML model 838, such as determining low frequency noise via accelerometers, detecting system disturbances, etc.

The hearing device 800 can include one or more communication devices 836. For example, the one or more communication devices 836 can include one or more radios coupled to one or more antenna arrangements that conform to an IEEE 802.8 (e.g., Wi-Fi®) or Bluetooth® (e.g., BLE, Bluetooth® 4.2, 5.0, 5.1, 5.2 or later) specification, for example. In addition, or alternatively, the hearing device 800 can include a near-field magnetic induction (NFMI) sensor (e.g., an NFMI transceiver coupled to a magnetic antenna) for effecting short-range communications (e.g., ear-to-ear communications, ear-to-kiosk communications). The communications device 836 may also include wired communications, e.g., universal serial bus (USB) and the like.

The communication device 836 is operable to allow the hearing device 800 to communicate with an external computing device 804, e.g., a mobile device 805 such as smartphone, laptop computer, table, etc. The external computing device 804 may also include a device usable by a clinician in a clinical setting, such as a desktop computer, test apparatus, etc. The external computing device 804 may also include a second hearing device 809, e.g. part of a pair of corresponding devices for both ears of the user. In one or more embodiments, the communication device 836 is operable to allow the hearing device 800 to communicate with other suitable external devices, e.g., a remote microphone or microphone array, etc.

The external computing device 804 includes a communications device 806 that is compatible with the communications device 836 for point-to-point or network communications. The external computing device 804 includes its own processor 808 and memory 810, the latter which may encompass both volatile and non-volatile memory. A user interface 807 facilitates interactions between the external computing device 804 and the hearing device 800, including access to settings that affect the ML model 838 and audiogram 839.

The hearing device 800 also includes a power source, which can be a conventional battery, a rechargeable battery (e.g., a lithium-ion battery), or a power source comprising a supercapacitor. In the embodiment shown in FIG. 8, the hearing device 800 includes a rechargeable power source 824 which is operably coupled to power management circuitry for supplying power to various components of the hearing device 800. The rechargeable power source 824 is coupled to charging circuitry 826. The charging circuitry 826 is electrically coupled to charging contacts on the housing 802 which are configured to electrically couple to corresponding charging contacts of a charger 828 when the hearing device 800 is placed in the charger.

The term “hearing device” of the present disclosure may refer to a wide variety of ear-level electronic devices that can aid a person with or without impaired hearing. This includes devices that can produce processed sound for persons with normal hearing, such as noise addition/cancellation to treat misophonia, or wireless earbuds for electronic sound playback. Hearing devices include, but are not limited to, behind-the-ear (BTE), in-the-ear (ITE), in-the-canal (ITC), invisible-in-canal (IIC), receiver-in-canal (RIC), receiver-in-the-ear (RITE) or completely-in-the-canal (CIC) type hearing devices or some combination of the above. Throughout this disclosure, reference is made to a “hearing device” or “ear-wearable device,” which is understood to refer to a system comprising a single left ear.

In summary, the embodiments described above addresses challenges in noise reduction algorithms for hearing aids, focusing on passing high-quality information to the SMS and responding appropriately to changes in the acoustic environment. By integrating DNN assistance into the traditional NR approach, it introduces a proactive approach to mitigate undesirable noise artifacts and delivers users an optimized auditory experience across various acoustic scenarios.

This document discloses numerous example embodiments, including but not limited to the following:

Example 1 is an ear-wearable device, comprising: an acoustic sensor that receives ambient sound and produces an input signal; an acoustic transducer that reproduces sound in an ear of a user based on an output signal; and a machine learning processing path coupled to the acoustic sensor and the acoustic transducer, the machine learning processing path comprising: an encoder layer that encodes the input signal into a latent representation; a sound enhancement layer that produces an enhanced latent representation that provides an audio enhancement independent of an individual hearing pathology; a tuning layer that is configured to represent a user-specific hearing pathology and that modifies the enhanced latent representation to provide a tuned and enhanced latent representation that tailors the audio enhancement to compensate for the user-specific hearing pathology; and a decoder layer that decodes the tuned and enhanced latent representation to produce the output signal.

Example 2 includes the ear-wearable device of example 1, wherein the sound enhancement layer enhances speech. Example 3 includes the ear-wearable device of examples 1 or 2, wherein the sound enhancement layer reduces noise. Example 4 includes the ear-wearable device of any preceding example, wherein compensating for the user-specific hearing pathology comprises a modification of dynamic range. Example 5 includes the ear-wearable device of example 4, wherein the modification of the dynamic range comprises compression.

Example 6 includes the ear-wearable device of any preceding example, wherein compensating for the user-specific hearing pathology comprises a change in frequency response. Example 7 includes the ear-wearable device of example 6, wherein the tuning layer is trained on a dataset of audiograms that describe different compensations for a population of hearing aid users. Example 8 includes the ear-wearable device of example 7, wherein, during use by a user, the tuning layer receives a specific audiogram that targets the user-specific hearing pathology, wherein the dataset of audiograms and the specific audiogram utilize a common format.

Example 9 includes the ear-wearable device of any preceding example, wherein one or both of the sound enhancement layer and the tuning layer comprise a fully-convolutional time-domain audio separation network. Example 10 includes the ear-wearable device of any preceding example, wherein one or both of the sound enhancement layer and the tuning layer comprise a recurrent neural network. Example 11 includes the ear-wearable device of any preceding example, wherein one or both of the sound enhancement layer and the tuning layer comprise a structured state space model. Example 12 includes the ear-wearable device of any preceding example, wherein one or both of the sound enhancement layer and the tuning layer comprise a transformer neural network.

Example 13 is a method of processing sound in an ear-wearable device, comprising: producing an input signal from one or more acoustic sensors of the ear-wearable device; inputting the input signal to a machine learning processing path, the machine learning processing path trained to perform: encoding the input signal into a latent representation; producing an enhanced latent representation that provides an audio enhancement independent of an individual hearing pathology; modifying the enhanced latent representation to provide a tuned and enhanced latent representation that tailors the audio enhancement to compensate for a user-specific hearing pathology; decoding the tuned and enhanced latent representation to produce an output signal; and reproducing the output signal in an ear of a user based via one or more acoustic transducers of the hearing device.

Example 14 is a method of training a machine learning model for an ear-wearable device comprising: compiling a dataset of audiograms that describe different compensations for a population of hearing aid users; compiling a training set comprising tuned audio representations formed by applying the audiograms to test audio data, the training set further comprising the audiograms associated with the tuned audio representations; and for each training iteration using the training set: choose from the training set a selected pair of the tuned audio representation and the associated audiogram; input the selected pair into the machine learning model to produce output audio data, the machine learning model comprising an encoder layer that receives the selected tuned audio representation, a sound enhancement layer, a tuning layer that receives the selected associated audiogram, and a decoder layer that provides the output audio data; determine a loss of the machine learning model based on one or both of: a difference between the output audio data and the selected tuned audio representation; and an enhancement metric of the output audio data; and adjust weights of the machine learning model to reduce the loss.

Example 15 includes the method of example 14, wherein the sound enhancement layer enhances speech, and wherein the enhancement metric comprises a scale-invariant source-to-noise ratio. Example 16 includes the method of example 14 or 15, wherein one or both of the sound enhancement layer and the tuning layer comprise a fully-convolutional time-domain audio separation network. Example 17 includes the method of any one of examples 14-16, wherein one or both of the sound enhancement layer and the tuning layer comprise comprises a recurrent neural network. Example 18 includes the method of any one of examples 14-17, wherein one or both of the sound enhancement layer and the tuning layer comprise a structured state space model. Example 19 includes the method of any one of examples 14-18, wherein one or both of the sound enhancement layer and the tuning layer comprise a transformer neural network.

Example 20 includes the method of any one of examples 14-19, wherein determining the tuned audio representation of the test audio data based on application of the selected audiogram to the test audio data comprises inputting the test audio data and the selected audiogram into a hearing aid simulator. Example 21 includes the method of any one of examples 14-20, further comprising, after the training: copying trained state data from the machine learning model into a corresponding machine learning model of a hearing device; and inputting a user-specific audiogram into a corresponding tuning layer of the corresponding machine learning model.

Although reference is made herein to the accompanying set of drawings that form part of this disclosure, one of at least ordinary skill in the art will appreciate that various adaptations and modifications of the embodiments described herein are within, or do not depart from, the scope of this disclosure. For example, aspects of the embodiments described herein may be combined in a variety of ways with each other. Therefore, it is to be understood that, within the scope of the appended claims, the claimed invention may be practiced other than as explicitly described herein.

All references and publications cited herein are expressly incorporated herein by reference in their entirety into this disclosure, except to the extent they may directly contradict this disclosure. Unless otherwise indicated, all numbers expressing feature sizes, amounts, and physical properties used in the specification may be understood as being modified either by the term “exactly” or “about.” Accordingly, unless indicated to the contrary, the numerical parameters set forth in the foregoing specification are approximations that can vary depending upon the desired properties sought to be obtained by those skilled in the art utilizing the teachings disclosed herein or, for example, within typical ranges of experimental error.

The recitation of numerical ranges by endpoints includes all numbers subsumed within that range (e.g., 1 to 5 includes 1, 1.5, 2, 2.75, 3, 3.80, 4, and 5) and any range within that range. Herein, the terms “up to” or “no greater than” a number (e.g., up to 50) includes the number (e.g., 50), and the term “no less than” a number (e.g., no less than 5) includes the number (e.g., 5).

The terms “coupled” or “connected” refer to elements being attached to each other either directly (in direct contact with each other) or indirectly (having one or more elements between and attaching the two elements). Either term may be modified by “operatively” and “operably,” which may be used interchangeably, to describe that the coupling or connection is configured to allow the components to interact to carry out at least some functionality (for example, a radio chip may be operably coupled to an antenna element to provide a radio frequency electric signal for wireless communication).

Terms related to orientation, such as “top,” “bottom,” “side,” and “end,” are used to describe relative positions of components and are not meant to limit the orientation of the embodiments contemplated. For example, an embodiment described as having a “top” and “bottom” also encompasses embodiments thereof rotated in various directions unless the content clearly dictates otherwise.

Reference to “one embodiment,” “an embodiment,” “certain embodiments,” or “some embodiments,” etc., means that a particular feature, configuration, composition, or characteristic described in connection with the embodiment is included in at least one embodiment of the disclosure. Thus, the appearances of such phrases in various places throughout are not necessarily referring to the same embodiment of the disclosure. Furthermore, the particular features, configurations, compositions, or characteristics may be combined in any suitable manner in one or more embodiments.

The words “preferred” and “preferably” refer to embodiments of the disclosure that may afford certain benefits, under certain circumstances. However, other embodiments may also be preferred, under the same or other circumstances. Furthermore, the recitation of one or more preferred embodiments does not imply that other embodiments are not useful and is not intended to exclude other embodiments from the scope of the disclosure.

As used in this specification and the appended claims, the singular forms “a,” “an,” and “the” encompass embodiments having plural referents, unless the content clearly dictates otherwise. As used in this specification and the appended claims, the term “or” is generally employed in its sense including “and/or” unless the content clearly dictates otherwise.

As used herein, “have,” “having,” “include,” “including,” “comprise,” “comprising” or the like are used in their open-ended sense, and generally mean “including, but not limited to.” It will be understood that “consisting essentially of,” “consisting of,” and the like are subsumed in “comprising,” and the like. The term “and/or” means one or all of the listed elements or a combination of at least two of the listed elements.

The phrases “at least one of,” “comprises at least one of,” and “one or more of” followed by a list refers to any one of the items in the list and any combination of two or more items in the list.

1. An ear-wearable device, comprising:
an acoustic sensor that receives ambient sound and produces an input signal;
an acoustic transducer that reproduces sound in an ear of a user based on an output signal; and
a machine learning processing path coupled to the acoustic sensor and the acoustic transducer, the machine learning processing path comprising:
an encoder layer that encodes the input signal into a latent representation;
a sound enhancement layer that produces an enhanced latent representation that provides an audio enhancement independent of an individual hearing pathology;
a tuning layer that is configured to represent a user-specific hearing pathology and that modifies the enhanced latent representation to provide a tuned and enhanced latent representation that tailors the audio enhancement to compensate for the user-specific hearing pathology; and
a decoder layer that decodes the tuned and enhanced latent representation to produce the output signal.

2. The ear-wearable device of claim 1, wherein the sound enhancement layer enhances speech.

3. The ear-wearable device of claim 1, wherein the sound enhancement layer reduces noise.

4. The ear-wearable device of claim 1, wherein compensating for the user-specific hearing pathology comprises a modification of dynamic range.

5. The ear-wearable device of claim 4, wherein the modification of the dynamic range comprises compression.

6. The ear-wearable device of claim 1, wherein compensating for the user-specific hearing pathology comprises a change in frequency response.

7. The ear-wearable device of claim 6, wherein the tuning layer is trained on a dataset of audiograms that describe different compensations for a population of hearing aid users.

8. The ear-wearable device of claim 7, wherein, during use by a user, the tuning layer receives a specific audiogram that targets the user-specific hearing pathology, wherein the dataset of audiograms and the specific audiogram utilize a common format.

9. The ear-wearable device of claim 1, wherein one or both of the sound enhancement layer and the tuning layer comprise a fully-convolutional time-domain audio separation network.

10. The ear-wearable device of claim 1, wherein one or both of the sound enhancement layer and the tuning layer comprise a recurrent neural network.

11. The ear-wearable device of claim 1, wherein one or both of the sound enhancement layer and the tuning layer comprise a structured state space model.

12. The ear-wearable device of claim 1, wherein one or both of the sound enhancement layer and the tuning layer comprise a transformer neural network.

13. A method of processing sound in an ear-wearable device, comprising:
producing an input signal from one or more acoustic sensors of the ear-wearable device;
inputting the input signal to a machine learning processing path, the machine learning processing path trained to perform:
encoding the input signal into a latent representation;
producing an enhanced latent representation that provides an audio enhancement independent of an individual hearing pathology;
modifying the enhanced latent representation to provide a tuned and enhanced latent representation that tailors the audio enhancement to compensate for a user-specific hearing pathology;
decoding the tuned and enhanced latent representation to produce an output signal; and
reproducing the output signal in an ear of a user based via one or more acoustic transducers of the hearing device.

14. A method of training a machine learning model for an ear-wearable device comprising:
compiling a dataset of audiograms that describe different compensations for a population of hearing aid users;
compiling a training set comprising tuned audio representations formed by applying the audiograms to test audio data, the training set further comprising the audiograms associated with the tuned audio representations; and
for each training iteration using the training set:
choose from the training set a selected pair of the tuned audio representation and the associated audiogram;
input the selected pair into the machine learning model to produce output audio data, the machine learning model comprising an encoder layer that receives the selected tuned audio representation, a sound enhancement layer, a tuning layer that receives the selected associated audiogram, and a decoder layer that provides the output audio data;
determine a loss of the machine learning model based on one or both of: a difference between the output audio data and the selected tuned audio representation; and an enhancement metric of the output audio data; and
adjust weights of the machine learning model to reduce the loss.

15. The method of claim 14, wherein the sound enhancement layer enhances speech, and wherein the enhancement metric comprises a scale-invariant source-to-noise ratio.

16. The method of claim 14, wherein one or both of the sound enhancement layer and the tuning layer comprise a fully-convolutional time-domain audio separation network.

17. The method of claim 14, wherein one or both of the sound enhancement layer and the tuning layer comprise comprises a recurrent neural network.

18. The method of claim 14, wherein one or both of the sound enhancement layer and the tuning layer comprise a structured state space model.

19. The method of claim 14, wherein one or both of the sound enhancement layer and the tuning layer comprise a transformer neural network.

20. The method of claim 14, wherein determining the tuned audio representation of the test audio data based on application of the selected audiogram to the test audio data comprises inputting the test audio data and the selected audiogram into a hearing aid simulator.

21. The method of claim 14, further comprising, after the training:
copying trained state data from the machine learning model into a corresponding machine learning model of a hearing device; and
inputting a user-specific audiogram into a corresponding tuning layer of the corresponding machine learning model.
